(19) United States
(12) Patent Application Publication
(10) Pub. No.: US 2014/0044129 A1
(43) Pub. Date: Feb. 13, 2014

(54) MULTICAST PACKET FORWARDING IN A NETWORK

(71) Applicants: Duane Edward Mentze, Roseville, CA (US); Parvez Syed Mohamed, Folsom, CA (US); Mark Allen Gravel, Roseville, CA (US)

(72) Inventors: Duane Edward Mentze, Roseville, CA (US); Parvez Syed Mohamed, Folsom, CA (US); Mark Allen Gravel, Roseville, CA (US)

(21) Appl. No.: 13/572,301

(22) Filed: Aug. 10, 2012

(51) Int. Cl. H04L 12/56

(52) U.S. Cl. 370/390

(57) ABSTRACT

One example includes a network device. The network device includes a plurality of ports and application specific logic. The application specific logic is to receive a multicast packet including client data and a header, the header including a route group identifier. The application specific logic is to determine a group of routed interfaces and an associated set of ports for each routed interface based on the route group identifier. The application specific logic is to replicate the client data to provide a packet for each routed interface and transmit, for each routed interface, the packet for the routed interface to the associated set of ports for the routed interface.

### BACKGROUND

Network devices, such as bridges, routers, and switches, forward packets from a source to a destination over a network. A bridge may be divided into multiple network devices, where the multiple network devices provide a single logical device. The single logical device includes a controlling bridge and one or more port extenders communicatively coupled to the controlling bridge. Conventionally, these devices lower the cost of adding more ports since the port extenders typically are less expensive than the controlling bridge. This is due to the controlling bridge being responsible for forwarding decisions. One example of a port extender is defined by Institute of Electrical and Electronics Engineers (IEEE) standard 802.1BR.

Multicast routing provides an efficient and scalable method for allowing multiple consumers to subscribe to a stream of data without the sender having to transmit individual streams to each consumer. For conventional port extenders (i.e., IEEE 802.1 BR compliant devices), only layer 2 bridging is supported for multicast packets. Therefore, to distribute multicast packets over several routable interfaces, such as Virtual Local Area Networks (VLANs), the multicast packets are forwarded for each routable interface. As such, when multicast packets are being routed through a port extender, the communication link from the controlling bridge to the port extender may be consumed by the same multicast packets being forwarded to multiple routable interfaces.

### BRIEF DESCRIPTION OF THE DRAWINGS

FIG. 1 is a block diagram illustrating one example of a network.

FIG. 2 is a block diagram illustrating one example of a controlling bridge.

FIG. 3 is a block diagram illustrating one example of a port extender.

FIG. 4 is a block diagram illustrating another example of a network.

FIG. 5 is a table illustrating one example of a multicast route table.

FIG. 6 is a table illustrating one example of a flow index to Route Group Identifier (RGID) table.

FIG. 7 is a table illustrating one example of a port extender RGID table for a first port extender.

FIG. 8 is a table illustrating one example of a port extender RGID table for a second port extender.

FIG. 9 is a table illustrating one example of a port extender RGID table for a third port extender.

FIG. 10 is a functional block diagram illustrating one example of packet forwarding through a controlling bridge and a port extender.

FIG. 11 is a flow diagram illustrating one example of a process for configuring a controlling bridge and a port extender for multicast routing.

FIG. 12 is a flow diagram illustrating one example of a process for forwarding multicast packets through a controlling bridge and a port extender.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined with each other, unless specifically noted otherwise.

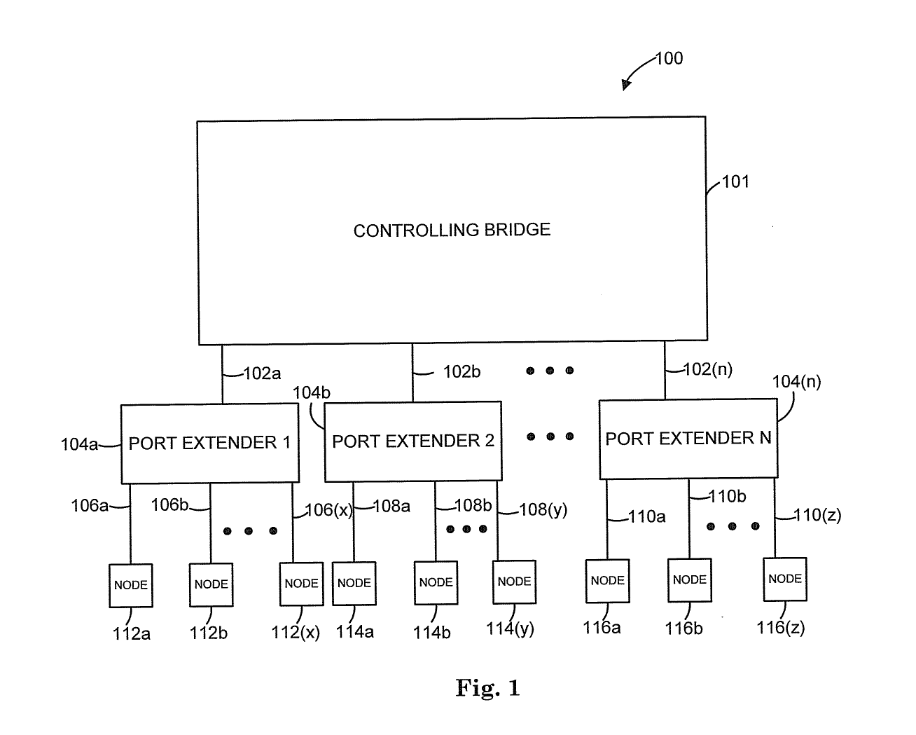

FIG. 1 is a block diagram illustrating one example of a network 100. Network 100 includes a controlling bridge 101, port extenders 104a-104(n), where “n” is any suitable number of port extenders, nodes 112a-112(x), where “x” is any suitable number of nodes 112, nodes 114a-114(y), where “y” is any suitable number of nodes 114, and nodes 116a-116(z), where “z” is any suitable number of nodes 116. Controlling bridge 101 is communicatively coupled to each port extender 104a-104(n) through a communication link 102a-102(n), respectively. Port extender 104a is communicatively coupled to each node 112a-112(x) through a communication link 106a-106(x), respectively. Port extender 104b is communicatively coupled to each node 114a-114(y) through a communication link 108a-108(y), respectively. Port extender 104(n) is communicatively coupled to each node 116a-116(z) through a communication link 110a-110(z), respectively.

Each node 112a-112(x), 114a-114(y), and 116a-116(z) includes a host, a client, another port extender (i.e., for aggregated port extenders), or other suitable devices for transmitting and receiving communications through network 100. Each node 112a-112(x), 114a-114(y), and 116a-116(z) may communicate with other nodes through network 100. Each node 112a-112(x), 114a-114(y), and 116a-116(z) may be member of a routed interface, such as a Virtual Local Area Network (VLAN).

Controlling bridge 101 routes packets through network 100. Controlling bridge 101 stores forwarding data (e.g., Media Access Control (MAC) addresses and Internet Protocol (IP) addresses) for nodes 112a-112(x), 114a-114(y), and 116a-116(z). Each incoming packet is transmitted to controlling bridge 101, which makes the decision as to where to forward the packet based on the packet and the forwarding data. Each port extender 104a-104(n) works in combination with controlling bridge 101 to forward packets to the designated node or nodes. Each port extender 104a-104(n) forwards each packet to a node or nodes based on a header attached to each packet by controlling bridge 101.

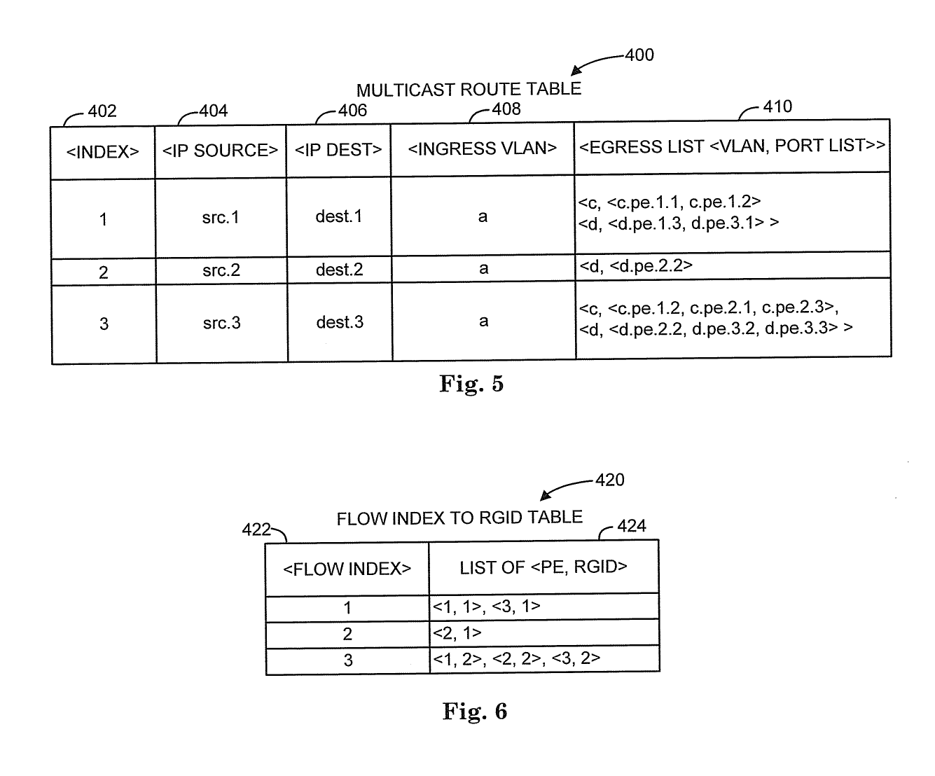

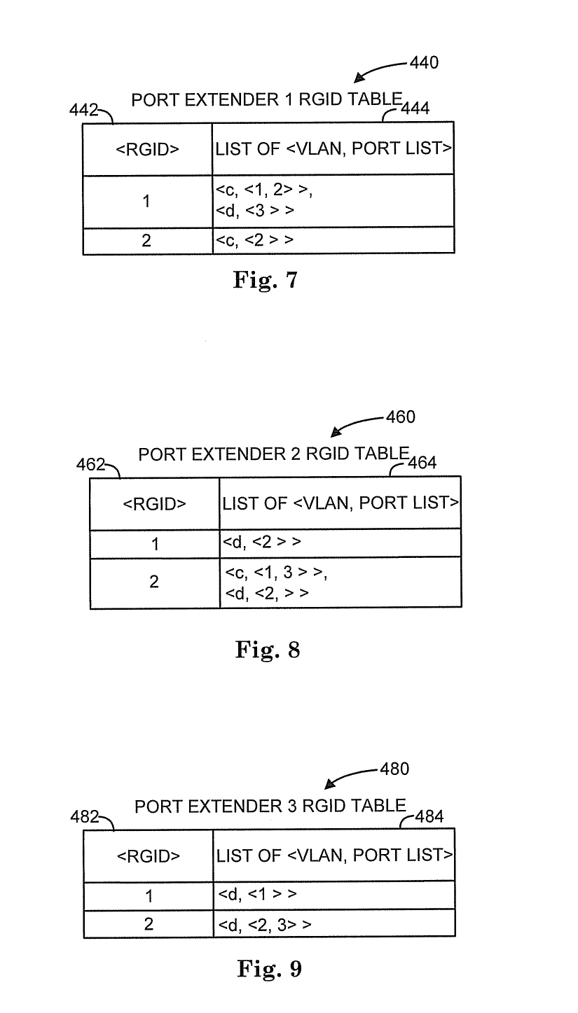

In operation, controlling bridge 101 configures forwarding tables including a multicast route table (described below with reference to FIG. 5) using conventional protocols. Controlling bridge 101 generates a flow index to Route Group Identifier (RGID) table (described below with reference to FIG. 6) based on the multicast route table. Based on the multicast route table and the flow index to RGID table, controlling bridge 101 configures each port extender 104a-104(n) with a port extender RGID table (described below with reference to FIGS. 7-9).

When a multicast packet is received at a port extender 104a-104(n) from a connected node 112a-112(x), 114a-114(y), and 116a-116(z), the port extender attaches a header to the packet that identifies the source port on which the packet was received and forwards the packet to controlling bridge 101. Controlling bridge 101 makes the forwarding decision for the multicast packet using the multicast route table, attaches a new header to the multicast packet including the source port and a destination for the packet, and forwards the packet to the appropriate port extenders 104a-104(n).

The new header identifies either the destination port (e.g. for a unicast packet), a replication group (e.g., for a multicast packet to a group of ports on a single VLAN (i.e., layer 2 bridging)), or an RGID (e.g., for a multicast packet to a plurality of groups of ports with each group of ports on a different VLAN (i.e., layer 3 multicast routing)). The port extender then forwards the packet to the appropriate port(s) based on the header. If the port extender receives a packet with an RGID, the port extender replicates the packet for each routed interface (i.e., VLAN) and forwards the packet to each port as defined in the port extender RGID table for the port extender. The port extender uses the source port identified in the header to remove the source port from the multicast group membership to prevent a multicast packet from being forwarded back to the source port from which the multicast packet originated.

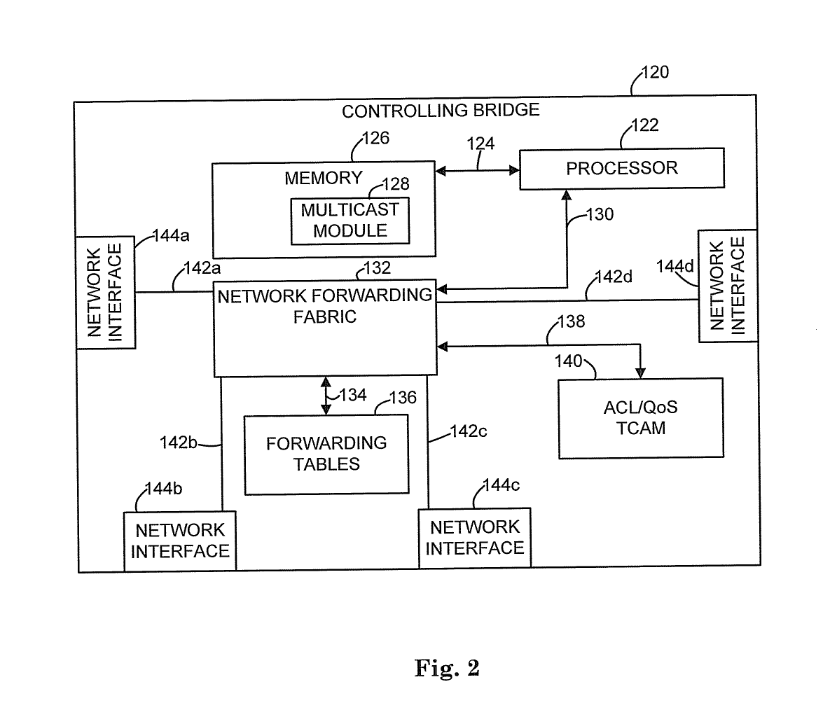

FIG. 2 is a block diagram illustrating one example of a controlling bridge 120. In one example, controlling bridge 120 provides controlling bridge 101 previously described and illustrated with reference to FIG. 1. Controlling bridge 120 includes a processor 122, a memory 126, a network forwarding fabric 132, forwarding tables 136, an Access Control List (ACL)/Quality of Service (QoS) Ternary Content-Addressable Memory (TCAM) 140, and network interfaces 144a-144d.

In one example, network forwarding fabric 132, forwarding tables 136, and ACL/QoS TCAM 140 constitute application specific logic, such as an Application Specific Integrated Circuit (ASIC). In another example, processor 122 and memory 126 including multicast module 128 constitute application specific logic. In another example, a combination of network forwarding fabric 132, forwarding tables 136, ACL/QoS TCAM 140, processor 122, and memory 126 including multicast module 128 constitute application specific logic.

Processor 122 is communicatively coupled to memory 126 through a communication link 124 and to network forwarding fabric 132 through a communication link 130. Network forwarding fabric 132 is communicatively coupled to forwarding tables 136 through a communication link 134, to ACL/QoS TCAM 140 through a communication link 138, and to network interfaces 144a-144d through a communication link 142a-142d, respectively. Each network interface 144a-144d is configured to be communicatively coupled to a port extender, such as a port extender 104a-104(n) previously described and illustrated with reference to FIG. 1.

Processor 122 includes a Central Processing Unit (CPU) or another suitable processor. In one example, memory 126 stores instructions executed by processor 122 for operating controlling bridge 120. Memory 126 includes any suitable combination of volatile and/or non-volatile memory, such as combinations of Random Access Memory (RAM), Read-Only Memory (ROM), flash memory, and/or other suitable memory. Memory 126 stores instructions executed by processor 122 including instructions for a multicast module 128. In one example, processor 122 executes instructions of multicast module 128 to implement the layer 3 multicast routing disclosed herein.

In one example, forwarding tables 136 include routing and bridging forwarding tables that are generated by controlling bridge 120 using conventional protocols. For multicast routed IP traffic, forwarding tables 136 include a multicast route table (described below with reference to FIG. 5). The multicast route table may be generated by using Protocol Independent Multicast (PIM) sparse or dense mode IP multicast routing (e.g., RFC 4601) or by using another suitable method. For IP version 4 multicast bridging, Internet Group Management Protocol (IGMP) snooping or another suitable method may be used to generate the multicast route table. For IP version 6 multicast bridging, Multicast Listener Discovery (MLD) or another suitable method may be used to generate the multicast route table. Forwarding tables 136 also include a flow index to RGID table (described below with reference to FIG. 6). The flow index to RGID table is generated by controlling bridge 120 based on the multicast route table to assign RGIDs to multicast traffic. In addition, based on the multicast route table and the flow index to RGID table, controlling bridge 120 generates port extender RGID tables (described below with reference to FIGS. 7-9) for configuring each connected port extender.

In operation, network forwarding fabric 132 receives packets from port extenders through network interfaces 144a-144d. Each packet includes a header identifying the source port for the packet. Controlling bridge 102 makes forwarding decisions for the packets based on data stored in forwarding tables 136 and based on data stored in ACL/QoS TCAM 140. Based on the forwarding decisions for a packet, controlling bridge 120 attaches a new header to the packet identifying the source port and the destination for the packet. The destination for each packet may identify a destination port, a replication group, or an RGID. The packets are then forwarded by network forwarding fabric 132 to a port extender(s) through the appropriate network interface(s) 144a-144d.

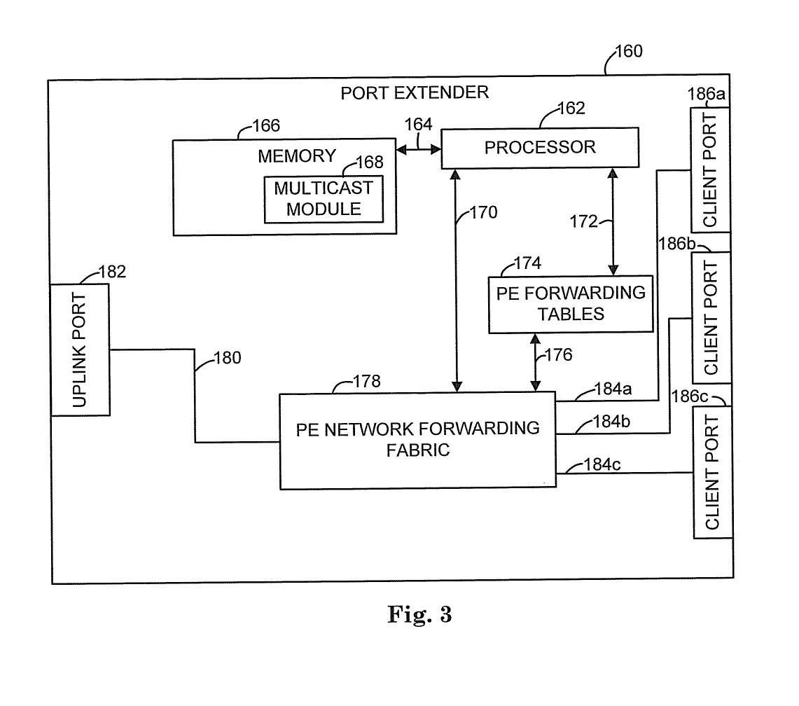

FIG. 3 is a block diagram illustrating one example of a port extender 160. In one example, port extender 160 provides each port extender 104a-104(n) previously described and illustrated with reference to FIG. 1. Port extender 160 includes a processor 162, a memory 166, Port Extender (PE) forwarding tables 174, a PE network forwarding fabric 178, an uplink port 182, and client ports 186a-186c. In other examples, port extender 160 includes another suitable number of client ports 186.

In one example, PE forwarding tables 174 and PE network forwarding fabric 178 constitute application specific logic, such as an ASIC. In another example, processor 162 and memory 166 including multicast module 168 constitute application specific logic. In another example, a combination of PE network forwarding fabric 178, PE forwarding tables 174, processor 162, and memory 166 including multicast module 168 constitute application specific logic.

Processor 162 is communicatively coupled to memory 166 through a communication link 164, to PE network forwarding fabric 178 through a communication link 170, and to PE forwarding tables 174 through a communication link 172. PE forwarding tables 174 are communicatively coupled to PE network forwarding fabric 178 through a communication link 176. PE network forwarding fabric 178 is communicatively coupled to uplink port 182 through a communication link 180 and to client ports 186a-186c through communication links 184a-184c, respectively. Uplink port 182 is configured to be communicatively coupled to a network interface of a controlling bridge, such as one of network interfaces 144a-144d of controlling bridge 120 previously described and illustrated with reference to FIG. 2. Each client port 186a-186c is configured to be communicatively coupled to a client, such as one of nodes 112a-112(x), 114a-114(y), and 116a-116(z) previously described and illustrated with reference to FIG. 1.

Processor 162 includes a CPU or another suitable processor. In one example, memory 166 stores instructions executed by processor 162 for operating port extender 160. Memory 166 includes any suitable combination of volatile and/or non-volatile memory, such as combinations of RAM, ROM, flash memory, and/or other suitable memory. Memory 166 stores instructions executed by processor 162 including instructions for a multicast module 168. In one example, processor 162 executes instructions of multicast module 168 to implement the layer 3 multicast routing disclosed herein.

PE forwarding tables 174 include a port extender RGID table (described below with reference to FIGS. 7-9). The port extender RGID table is configured by the controlling bridge connected to port extender 160 through uplink port 182.

In operation, PE network forwarding fabric 178 receives packets from clients via client ports 186a-186c. Port extender 160 attaches a header to each packet identifying the source port 186a-186c from which the packet was received. PE network forwarding fabric 178 then forwards the packet to a controlling bridge via uplink port 182.

PE network forwarding fabric 178 receives packets from a controlling bridge via uplink port 182. Each packet received from the controlling bridge includes a header identifying the source port and a destination for the packet. The destination may identify a destination port, a replication group, or an RGID. PE network forwarding fabric 178 then forwards the packet to clients via client ports 186a-186c based on the header of the packet and data stored in PE forwarding tables 174. If the destination of a packet identifies a destination port, the port extender forwards the packet to the identified client port 186a-186c. If the destination of a packet identifies a replication group, the port extender forwards the packet to the group of identified client ports 186a-186c. If the destination of a packet identifies an RGID, the port extender replicates the packet for each routed interface and for each routed interface forwards the packet to the group of client ports 186a-186c defined in the port extender RGID table.

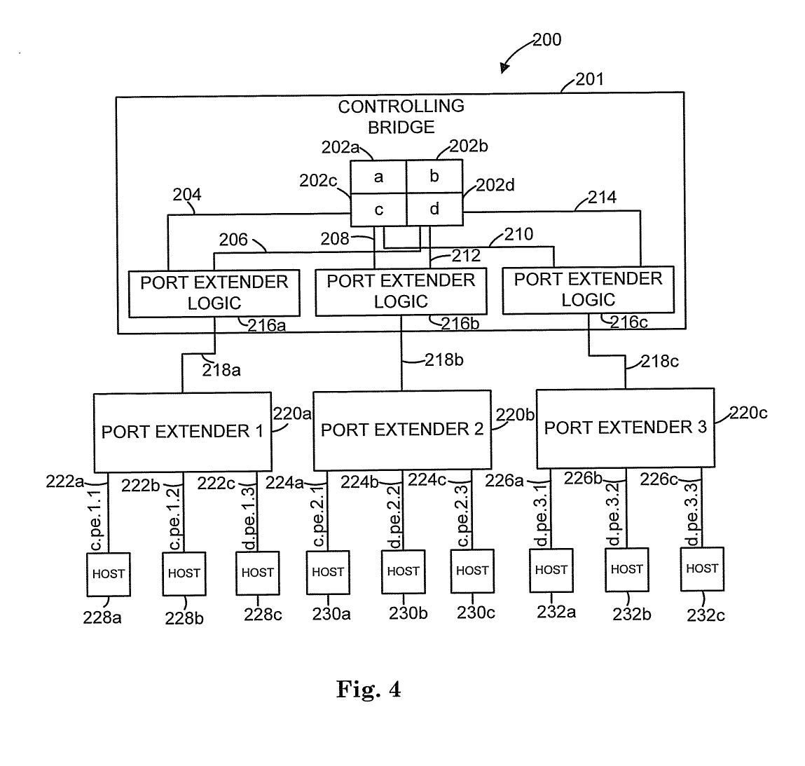

FIG. 4 is a block diagram illustrating another example of a network 200. Network 200 includes a controlling bridge 201, a first port extender 220a, a second port extender 220b, a third port extender 220c, and hosts 228a-228c, 230a-230c, and 232a-232c. In one example, controlling bridge 201 is similar to controlling bridge 120 previously described and illustrated with reference to FIG. 2, and each port extender 220a-220c is similar to port extender 160 previously described and illustrated with reference to FIG. 3.

In this example, controlling bridge 201 routes packets to and between four VLANs indicated by VLAN “a” 202a, VLAN “b” 202b, VLAN “c” 202c, and VLAN “d” 202d. Controlling bridge 201 includes port extender logic 216a-216c. In one example, port extender logic 216a-216c is provided by processor 122, memory 126, network forwarding fabric 132, forwarding tables 136, ACL/QoS TCAM 138, and network interfaces 144a-144d previously described and illustrated with reference to FIG. 2.

Each port extender logic 216a-216c is communicatively coupled to a port extender 220a-220c through a communication link 218a-218c, respectively. Port extender 220a is communicatively coupled to hosts 228a-228c through communication links 222a-222c, respectively. Port extender 220b is communicatively coupled to hosts 230a-230c through communication links 224a-224c, respectively. Port extender 220c is communicatively coupled to hosts 232a-232c through communication links 226a-226c, respectively.

Packets for VLAN 202c are routed to port extender logic 216a through a communication link 204, to port extender logic 216b through a communication link 208, and to port extender logic 216c through a communication link 210. Packets from VLAN 202d are routed to port extender logic 216a through a communication link 206, to port extender logic 216b through a communication link 212, and to port extender logic 216c through a communication link 214.

In this example, hosts 228a, 228b, 230a, and 230c are members of VLAN “c”, and hosts 228c, 230b, and 232a-232c are members of VLAN “d”. In addition, each host has an address based on the VLAN, the port extender number, and the port of the port extender. For example, host 228a has an address “c.pe.1.1”, which indicates that host 228a is a member of VLAN “c” and is communicatively coupled to the first port of the first port extender 220a. Host 228b has an address “c.pe.1.2”, which indicates that host 228b is a member of VLAN “c” and is communicatively coupled to the second port of the first port extender 220a. Likewise, host 228c has an address “d.pe.1.3”, which indicates that host 228c is a member of VLAN “d” and is communicatively coupled to the third port of the first port extender 220a.

The following examples illustrated in FIGS. 5-9 are based on the example VLANs “a”, “c”, and “d” and the example addresses of hosts 228a-228c, 230a-230c, and 232a-232c illustrated in FIG. 4.

FIG. 5 is a table illustrating one example of a multicast route table 400. Multicast route table 400 is stored in controlling bridge 201 previously described and illustrated with reference to FIG. 4. In one example, multicast route table 400 is part of forwarding tables 136 of a controlling bridge 120 as previously described and illustrated with reference to FIG. 2.

Multicast route table 400 stores data for each multicast flow so that the controlling bridge can make forwarding decisions for multicast packets. Multicast route table 400 includes an index field 402, an IP source field 404, an IP destination field 406, an ingress VLAN field 408, and an egress list field 410. The egress list field includes a list of VLANs, and a port list for each VLAN. Multicast route table 400 is generated by a controlling bridge using conventional protocols, such as PIM sparse or dense mode IP multicast routing, IGMP snooping, MLD, or by using other suitable protocols.

In this example, a multicast packet having an IP source “src.1”, an IP destination “dest.1”, and an ingress VLAN “a”, includes an egress list including VLANs “c” and “d”. For VLAN “c”, the packet is to be forwarded to addresses “c.pe.1.1” and “c.pe.1.2”. For VLAN “d”, the packet is to be forwarded to addresses “d.pe.1.3” and “d.pe.3.1”. This record has been assigned an index of “1”. A multicast packet having an IP source “src.2”, an IP destination “dest.2”, and an ingress VLAN “a”, includes an egress list including VLAN “d”. For VLAN “d”, the packet is to be forwarded to address “d.pe.2.2”. This record has been assigned an index of “2”. Likewise, a multicast packet having an IP source “src.3”, an IP destination “dest.3”, and an ingress VLAN “a”, includes an egress list including VLANs “c” and “d”. For VLAN “c”, the packet is to be forwarded to addresses “c.pe.1.2”, “c.pe.2.1”, and “c.pe.2.3”. For VLAN “d”, the packet is to be forwarded to addresses “d.pe.2.2”, “d.pe.3.2”, and “d.pe.3.3”. This record has been assigned an index of “3”.

Over time, records for new flows may be added to multicast route table 400 and records within multicast route table 400 may be removed. Therefore, multicast route table 400 may become sparse (i.e., may have unused entries between used entries).

FIG. 6 is a table illustrating one example of a flow index to Route Group Identifier (RGID) table 420. Flow index to RGID table 420 is stored in the controlling bridge 201 previously described and illustrated with reference to FIG. 4. In one example, flow index to RGID table 420 is part of forwarding tables 136 of a controlling bridge 120 as previously described and illustrated with reference to FIG. 2.

Flow index to RGID table 420 stores data for forwarding multicast packets. Flow index to RGID table 420 includes a flow index field 422 and a list of PEs, with each PE assigned an RGID. Each flow index value stored in flow index field 422 corresponds to an index value stored in index field 402 of multicast route table 400 previously described and illustrated with reference to FIG. 5. In one example, flow index to RGID table 420 may be collapsed into multicast route table 400 since both tables are indexed the same. Flow index to RGID table 420 is generated by a controlling bridge based on multicast route table 400.

In this example, for flow index “1”, list field 424 includes “<1, 1>, <3, 1>”, which indicates that a packet having a flow index of “1” is to be forwarded to the first port extender and the third port extender. In addition, both the first port extender and the third port extender for flow index “1” have been assigned an RGID of “1”. For flow index “2”, list field 424 includes “<2, 1>”, which indicates that a packet having a flow index of “2” is to be forwarded to the second port extender. In addition, the second port extender for flow index “2” has been assigned an RGID of “1”. Likewise, for flow index “3”, list field 424 includes “<1, 2>, <2, 2>, <3, 2>”, which indicates that a packet having a flow index of “3” is to be forwarded to the first port extender, the second port extender, and the third port extender. In addition, the first port extender, the second port extender, and the third port extender for flow index “3” have been assigned an RGID of “2” since the RGID of “1” has already been assigned to each port extender in the previous entries of flow index to RGID table 420.

In one example, the RGID starts at 1 at the first encounter of a given port extender and then increments for each further encounter of the given port extender. Therefore, the RGID for the same flow index 422 could be different in each port extender. For example, if the third port extender were also part of flow index “2”, the entry for flow index “2” would be “<2, 1>, <3, 2>”, and the entry for flow index “3” would be “<1, 2>, <2, 2>, <3, 3>”.

In operation, in response to receiving a multicast packet from a port extender, controlling bridge 201 attaches a header to the packet and forwards the packet to the appropriate port extenders. For example, for a packet for flow index “1”, controlling bridge 201 attaches a header including RGID “1” to the packet and forwards the packet once to first port extender 220a and once to third port extender 220c. For a packet for flow index “2”, controlling bridge 201 attaches a header including RGID “1” to the packet and forwards the packet once to second port extender 220b. Likewise, for a packet for flow index “3”, controlling bridge 201 attaches a header including RGID “2” to the packet and forwards the packet once to first port extender 220a, once to second port extender 220b, and once to third port extender 220c.

FIG. 7 is a table illustrating one example of a port extender RGID table 440 for first port extender 220a. Port extender RGID table 440 is stored in port extender 220a previously described and illustrated with reference to FIG. 4. In one example, port extender RGID table 440 is part of PE forwarding tables 174 of a port extender 160 as previously described and illustrated with reference to FIG. 3.

Port extender RGID table 440 stores data for forwarding multicast packets. Port extender RGID table 440 includes an RGID field 442 and a field 444 including a list of VLANs (i.e., routed interfaces) and an associated port list (i.e., an associated set of ports) for each VLAN. Port extender RGID table 440 links each RGID to a list of VLANs and an associated port list for each VLAN. In other examples, port extender RGID table 440 includes an RGID field whose value points to a linked list of replication groups, with one replication group per VLAN.

Port extender RGID table 440 is generated by controlling bridge 201 (FIG. 4) based on multicast route table 400 (FIG. 5) and flow index to RGID table 420 (FIG. 6). After generating and/or updating the port extender RGID table, controlling bridge 201 configures port extender 220a by transmitting the port extender to RGID table entries to port extender 220a.

In this example, RGID “1” is assigned to VLANs “c” and “d”. For VLAN “c”, the port list includes ports 1 and 2. For VLAN “d”, the port list includes port 3. These values are based on the record of index “1” of multicast route table 400 (FIG. 5) and the record of flow index “1” of flow index to RGID table 420 (FIG. 6). RGID “2” is assigned to VLAN “c”. For VLAN “c”, the port list includes port 2. These values are based on the record of index “3” of multicast route table 400 and the record of flow index “3” of flow index to RGID table 420.

In operation, in response to port extender 220a receiving a packet including an RGID of “1” from controlling bridge 201, port extender 220a replicates the packet for VLAN “c” and forwards the packet to ports 1 and 2 of port extender 220a. Port extender 220a also replicates the packet for VLAN “d” and forwards the packet to port 3 of port extender 220a. In this way, a packet including an RGID of “1” is forwarded from port extender 220a to hosts 228a, 228b, and 228c (FIG. 4). Likewise, in response to port extender 220a receiving a packet including an RGID of “2” from controlling bridge 201, port extender 220a replicates the packet for VLAN “c” and forwards the packet to port 2 of port extender 220a. In this way, a packet including an RGID of “2” is forwarded from port extender 220a to host 228b.

FIG. 8 is a table illustrating one example of a port extender RGID table 460 for second port extender 220b. Port extender RGID table 460 is stored in port extender 220b previously described and illustrated with reference to FIG. 4. In one example, port extender RGID table 460 is part of PE forwarding tables 174 of a port extender 160 as previously described and illustrated with reference to FIG. 3.

Port extender RGID table 460 stores data for forwarding multicast packets. Port extender RGID table 460 includes an RGID field 462 and a field 464 including a list of VLANs and an associated port list for each VLAN. Port extender RGID table 460 is generated by controlling bridge 201 (FIG. 4) based on multicast route table 400 (FIG. 5) and flow index to RGID table 420 (FIG. 6). After generating and/or updating the port extender RGID table, controlling bridge 201 configures port extender 220b by transmitting the port extender to RGID table entries to port extender 220b.

In this example, RGID “1” is assigned to VLAN “d”. For VLAN “d”, the port list includes port 2. These values are based on the record of index “2” of multicast route table 400 (FIG. 5) and the record of flow index “2” of flow index to RGID table 420 (FIG. 6). RGID “2” is assigned to VLANs “c” and “d”. For VLAN “c”, the port list includes ports 1 and 3. For VLAN “d”, the port list includes port 2. These values are based on the record of index “3” of multicast route table 400 and the record of flow index “3” of flow index to RGID table 420.

In operation, in response to port extender 220b receiving a packet including an RGID of “1” from controlling bridge 201, port extender 220b replicates the packet for VLAN “d” and forwards the packet to port 2 of port extender 220b. In this way, a packet including an RGID of “1” is forwarded from port extender 220b to host 230b (FIG. 4). Likewise, in response to port extender 220b receiving a packet including an RGID of “2” from controlling bridge 201, port extender 220b replicates the packet for VLAN “c” and forwards the packet to ports 1 and 3 of port extender 220b. Port extender 220b also replicates the packet for VLAN “d” and forwards the packet to port 2 of port extender 220b. In this way, a packet including an RGID of “2” is forwarded from port extender 220b to hosts 230a, 230b, and 230c.

FIG. 9 is a table illustrating one example of a port extender RGID table 480 for third port extender 220c. Port extender RGID table 480 is stored in port extender 220c previously described and illustrated with reference to FIG. 4. In one example, port extender RGID table 480 is part of PE forwarding tables 174 of a port extender 160 as previously described and illustrated with reference to FIG. 3.

Port extender RGID table 480 stores data for forwarding multicast packets. Port extender RGID table 480 includes an RGID field 482 and a field 484 including a list of VLANs and an associated port list for each VLAN. Port extender RGID table 480 is generated by controlling bridge 201 (FIG. 4) based on multicast route table 400 (FIG. 5) and flow index to RGID table 420 (FIG. 6). After generating and/or updating the port extender RGID table, controlling bridge 201 configures port extender 220c by transmitting the port extender to RGID table entries to port extender 220c.

In this example, RGID “1” is assigned to VLAN “d”. For VLAN “d”, the port list includes port 1. These values are based on the record of index “1” of multicast route table 400 (FIG. 5) and the record of flow index “1” of flow index to RGID table 420 (FIG. 6). RGID “2” is assigned to VLAN “d”. For VLAN “d”, the port list includes ports 2 and 3. These values are based on the record of index “3” of multicast route table 400 and the record of flow index “3” of flow index to RGID table 420.

In operation, in response to port extender 220c receiving a packet including an RGID of “1” from controlling bridge 201, port extender 220c replicates the packet for VLAN “d” and forwards the packet to port 1 of port extender 220c. In this way, a packet including an RGID of “1” is forwarded from port extender 220c to host 232a (FIG. 4). Likewise, in response to port extender 220c receiving a packet including an RGID of “2” from controlling bridge 201, port extender 220c replicates the packet for VLAN “d” and forwards the packet to ports 2 and 3 of port extender 220c. In this way, a packet including an RGID of “2” is forwarded from port extender 220c to hosts 232b and 232c.

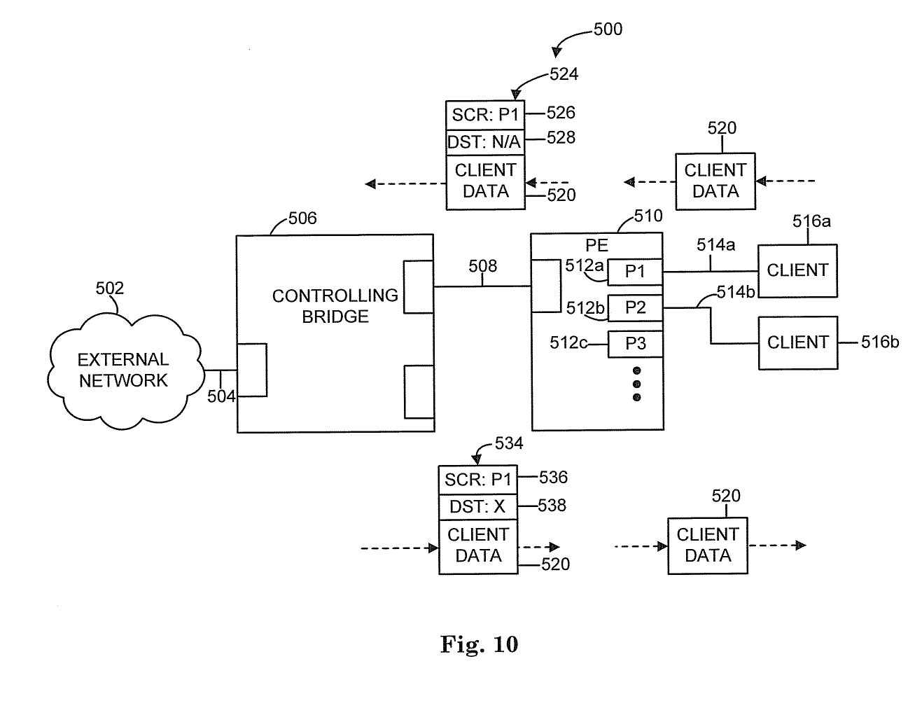

FIG. 10 is a functional block diagram illustrating one example of packet forwarding 500 through a controlling bridge 506 and a port extender 510. In one example, controlling bridge 506 is provided by a controlling bridge 120 previously described and illustrated with reference to FIG. 2, and port extender 510 is provided by a port extender 160 previously described and illustrated with reference to FIG. 3.

Controlling bridge 506 is communicatively coupled to an external network 502 through a communication link 504. Controlling bridge 506 is communicatively coupled to port extender 510 through a communication link 508. Port extender 510 includes a plurality of client ports, including port P1 512a, port P2 512b, and port P3 512c. Port P1 512a is communicatively coupled to a client 516a through a communication link 514a. Port P2 512b is communicatively coupled to a client 516b through a communication link 514b.

In operation of one example, client 516a transmits a packet to port P1 512a of port extender 510 as indicated at 520. The packet transmitted by client 516a includes client data. Port extender 510 receives the packet on port P1 512a and attaches a header to the packet that identifies the source port on which the packet was received. Port extender 510 then transmits the packet including the header to controlling bridge 506. The packet transmitted from port extender 510 to controlling bridge 506 is indicated at 524. Packet 524 includes a header including a source field 526 and a destination field 528. The source field 526 identifies the source of the packet (i.e., port P1 in this example), and the destination field 528 is not yet applicable. Packet 524 also includes the client data 520.

In response to receiving packet 524, controlling bridge 506 makes a forwarding decision for the packet based on forwarding tables (e.g., a multicast route table and a flow index to RGID table). Based on the forwarding decision, controlling bridge 506 attaches a new or updated header to the packet that identifies the source port of the packet and the destination for the packet. Controlling bridge 506 then transmits the packet including the new or updated header to port extender 510. The packet transmitted from controlling bridge 506 to port extender 510 is indicated at 534. Packet 534 includes a header including a source field 536 and a destination field 538. The source field 536 identifies the source of the packet (i.e., port P1 in this example), and the destination field 538 identifies the destination “X” for the packet. Packet 534 also includes the client data 520.

The destination “X” may be one of three values. The destination “X” may identify a destination port (e.g., port P2), a replication group ID that identifies a group of ports for a single routed interface (e.g., ports P2 and P3), or an RGID that identifies a group of ports for each of a plurality of routed interfaces. In response to receiving packet 534, port extender 510 forwards the packet based on the source field 536, the destination field 538, and forwarding tables (e.g., a port extender RGID table). The packet forwarded to a client includes client data 520 and not the header used by port extender 510 to forward the packet.

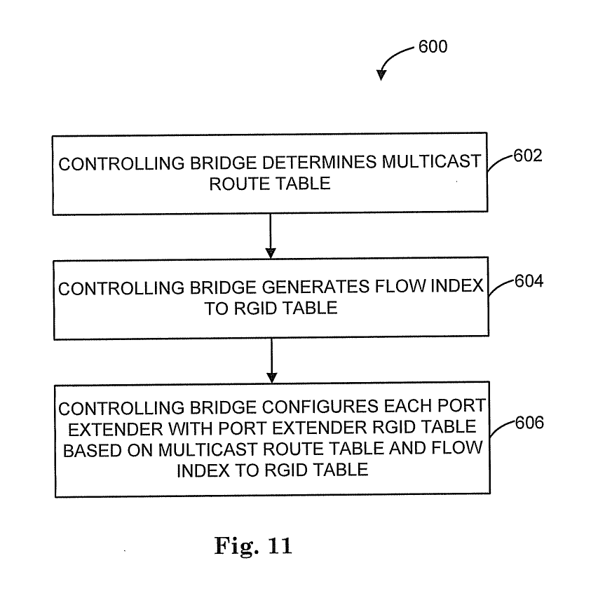

FIG. 11 is a flow diagram illustrating one example of a process 600 for configuring a controlling bridge and a port extender for multicast routing. At 602, the controlling bridge determines the multicast route table, such as multicast route table 400 previously described and illustrated with reference to FIG. 5. At 604, the controlling bridge generates a flow index to RGID table, such as flow index to RGID table 420 previously described and illustrated with reference to FIG. 6. The controlling bridge generates the flow index to RGID table based on the multicast route table. At 606, the controlling bridge configures each port extender with a port extender RGID table based on the multicast route table and the flow index to RGID table. Examples of port extender RGID tables have been previously described and illustrated with reference to FIGS. 7-9.

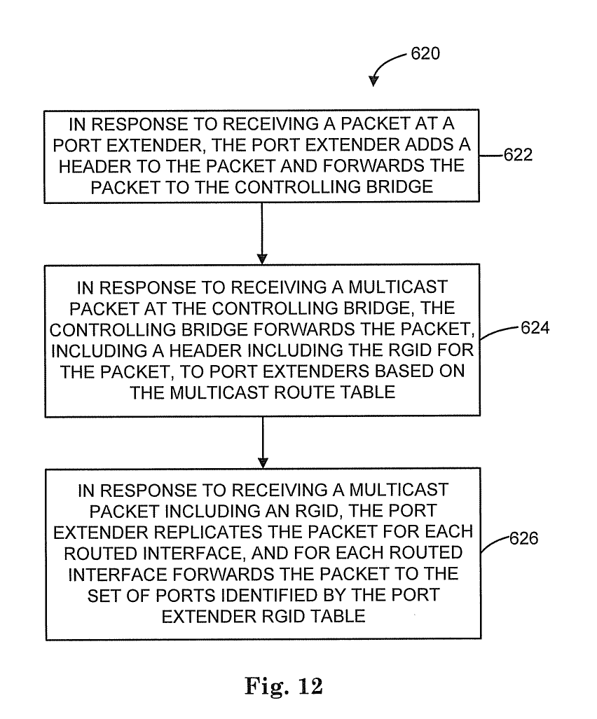

FIG. 12 is a flow diagram illustrating one example of a process 620 for forwarding multicast packets through a controlling bridge and a port extender. At 622, in response to receiving a packet at a port extender, the port extender adds a header to the packet and forwards the packet to the controlling bridge. The header of the packet identifies the source port on which the packet was received. At 624, in response to receiving a multicast packet at the controlling bridge, the controlling bridge forwards the packet, including a header including the RGID for the packet for each port extender, to the port extenders based on the multicast route table. The RGID for the packet for each port extender is determined from the flow index to RGID table. At 626, in response to receiving a multicast packet including an RGID, the port extender replicates the packet for each routed interface, and for each routed interface forwards the packet to the set of ports identified by the port extender RGID table.

By forwarding multicast packets as disclosed herein using layer 3 multicast routing, multicast packets are transmitted only one time to each port extender, rather than one time per routed interface. Each port extender then replicates the multicast packet for each routed interface and forwards the multicast packet to the associated ports for each routed interface. Therefore, traffic on the network is reduced compared to layer 2 bridging.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A network device comprising:
a plurality of ports; and
application specific logic to:
receive a multicast packet including client data and a header, the header including a route group identifier;
determine a group of routed interfaces and an associated set of ports for each routed interface based on the route group identifier;
replicate the client data to provide a packet for each routed interface; and
transmit, for each routed interface, the packet for the routed interface to the associated set of ports for the routed interface.

2. The network device of claim 1, wherein the application specific logic comprises a forwarding table that stores a plurality of route group identifiers, each route group identifier linked to a group of routed interfaces and an associated set of ports for each routed interface.

3. The network device of claim 1, wherein the network device comprises a port extender.

4. The network device of claim 3, wherein the port extender is coupled to a plurality of nodes.

5. The network device of claim 3, wherein the multicast packet is received from a controlling bridge.

6. A network device comprising:
a plurality of network interfaces, each network interface to couple to a port extender; and
application specific logic to:
determine forwarding data for multicast flows including a list of routed interfaces and an associated port list for each routed interface, the port list identifying port extenders;
assign, for each multicast flow, a route group identifier to each port extender identified by the port list;
configure each port extender with the assigned route group identifiers for the port extender, each route group identifier linked to a list of routed interfaces and an associated port list for each routed interface;
receive a multicast packet;
determine a route group identifier for each port extender to which the multicast packet is to be forwarded; and
for each port extender to which the multicast packet is to be forwarded, attach a header to the multicast packet including the route group identifier and transmit the multicast packet including the header to the port extender.

7. The network device of claim 6, wherein the network device comprises a controlling bridge.

8. The network device of claim 7, wherein the controlling bridge is coupled to a plurality of port extenders.

9. The network device of claim 6, wherein each routed interface comprises a Virtual Local Area Network (VLAN).

10. The network device of claim 6, wherein the application specific logic determines the forwarding data via one of Protocol Independent Multicast (PIM) mode Internet Protocol (IP) multicast routing, Internet Group Management Protocol (IGMP) snooping, and Multicast Listener Discovery (MLD).

11. A method for forwarding multicast packets, the method comprising:
receiving, in a network device, a multicast packet having a header including a route group identifier, the route group identifier identifying a list of routed interfaces and an associated port list for each routed interface;
replicating, in the network device, the multicast packet for each routed interface identified by the route group identifier; and
for each routed interface, transmitting the multicast packet to the listed ports for the routed interface.

12. The method of claim 11, wherein receiving the multicast packet comprises receiving the multicast packet from a controlling bridge.

13. The method of claim 12, further comprising:
configuring the list of routed interfaces and the associated port list for each routed interface via the controlling bridge based on forwarding tables stored in the controlling bridge.

14. The method of claim 11, wherein the network device comprises a port extender.

15. The method of claim 11, wherein receiving the multicast packet comprises receiving an Internet Protocol (IP) multicast packet.
